(19) United States
(12) Patent Application Publication
(10) Pub. No.: US 2006/0185647 A1
(43) Pub. Date: Aug. 24, 2006

(54) Fuel injection system for combustion engines

(76) Inventor: Holger Rapp, Ditzingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/564,631

(22) PCT Filed: Jul. 13, 2004
(86) PCT No.: PCT/DE04/01520

§ 371 Date: Jan. 13, 2006

(30) Foreign Application Priority Data
Jul. 17, 2003 (DE) 103 32 484.4

(51) Int. Cl. F02M 57/02

(52) U.S. Cl. 123/446

(57) ABSTRACT

A fuel injection system for internal combustion engines, including a high-pressure part and a low-pressure part. In the high-pressure part, fuel is delivered to a high-pressure reservoir via a high-pressure pump and a high-pressure line. Injectors are supplied from the high-pressure reservoir. In the low-pressure part, the injectors communicate with a low-pressure reservoir where a pressure of ≦50 bar is maintained by a pressure holding valve. At a pressure in the low-pressure reservoir above the opening pressure of the pressure holding valve, the fuel is returned to the fuel container via a return line. The low-pressure reservoir communicates with the high-pressure line of the high-pressure part via an overflow valve and an overflow line.

### FIELD OF THE INVENTION

In self-igniting internal combustion engines, fuel injection systems with a high-pressure reservoir are employed. When piezoelectrically controlled injectors are used, a return counterpressure is necessary in the region of the hydraulic coupler. A return counterpressure is achieved by the connections of the injectors with a low-pressure reservoir. To assure reliable operation upon starting of the engine, the low-pressure reservoir must first be filled.

### BACKGROUND OF THE INVENTION

Injectors controlled with a piezoelectric actuator have very much shorter switching times than injectors that are controlled with a magnet valve or electrohydraulically. If the function of the piezoelectric actuator is to be assured over the entire rpm range, the piezoelectrically controlled injectors require a return counterpressure of approximately 10 bar in the region of their hydraulic coupler. The return counterpressure is attained by equipping fuel injection systems, already equipped with piezoelectrically controlled injectors, with a low-pressure reservoir. The low-pressure reservoir is closed off by a pressure holding valve, which in the direction from the injector to the tank acts as an overflow valve. In this way, in operation of the engine, the return flow quantity from the injectors is dammed up to a defined return pressure of approximately 10 bar.

In the direction from the fuel container to the low-pressure reservoir, the pressure holding valve acts as a check valve, with an opening pressure of approximately 0.3 bar. In fuel injection systems with an electric low-pressure prefeed pump, the outlet side of the pressure holding valve communicates hydraulically with the pumping side of the low-pressure prefeed pump. In this way, the pumping pressure of the low-pressure prefeed pump, which is in the range of from 3 to 5 bar, is also immediately available to the low-pressure reservoir upon starting of the engine. As a result, the supply to the injectors is assured even if the low-pressure reservoir is not completely filled with fuel. This applies especially to the case when the low-pressure reservoir has been removed for servicing and in particular upon initial starting of the fuel injection system in the engine-building factory.

Often, however, fuel injection systems without a low-pressure prefeed pump are used. However, in these fuel injection systems, there is no possibility of filling the low-pressure reservoir before the engine is started.

### SUMMARY OF THE INVENTION

The injectors of a fuel injection system for self-igniting internal combustion engines are either driven with the aid of piezoelectric actuators or magnet valves or are driven electrohydraulically. If injectors that are equipped with a piezoelectric actuator are used, then to assure the function over the entire rpm range of the engine, a return counterpressure of approximately 10 bar is necessary. The return counterpressure is achieved by causing the injectors to communicate on the return side with a low-pressure reservoir. By means of the fuel pressure in the low-pressure reservoir, closed off by a pressure holding valve, the function of the piezoelectrically controlled injectors is assured. To assure the function of the injectors upon starting of the engine as well, it is necessary that the low-pressure reservoir be filled before the engine is started.

In the fuel injection system, designed according to the invention, for self-igniting internal combustion engines, the low-pressure reservoir is filled, before the engine is started, via an overflow valve which is connected between the high-pressure pump of the fuel injection system and the low-pressure reservoir. In this way, it becomes possible to fill the low-pressure reservoir even without a low-pressure prefeed pump upstream of it.

A fuel injection system provided with a high-pressure reservoir for self-igniting internal combustion engines includes a high-pressure part and a low-pressure part. In the high-pressure part, fuel from a fuel container is delivered to a high-pressure reservoir via a high-pressure pump and a high-pressure line. Injectors communicate with the high-pressure reservoir via high-pressure supply lines. The supply of fuel to the injectors from the high-pressure reservoir is done via the high-pressure supply lines.

For the operation of the injectors, it is necessary for the hydraulic coupler, employed for controlling the valve needle, to be acted upon by a return counterpressure. This is achieved by providing that the injectors in the low-pressure part communicate with a low-pressure reservoir via injector return lines. In the low-pressure reservoir, by means of a pressure holding valve, a pressure of ≦50 bar, preferably ≦20 bar and in particular ≦10 bar, is maintained. As soon as the pressure in the low-pressure reservoir exceeds the opening pressure of the pressure holding valve, the fuel is returned to the fuel container via a return line.

For building up the requisite pressure in the low-pressure reservoir, the low-pressure reservoir is made to communicate with the high-pressure line of the high-pressure part via an overflow valve and an overflow line.

For filling the low-pressure reservoir, the overflow valve is designed such that the overflow valve is opened when the high-pressure part is pressure-relieved, and a connection from the high-pressure part to the low-pressure reservoir is thus established. The closing pressure of the overflow valve is dimensioned such that the overflow valve closes at a pressure in the range of from 3 to 7 bar. Thus the closing pressure of the overflow valve is below the opening pressure of the pressure holding valve.

The closing pressure of the overflow valve is generated by the provision of a valve spring in the overflow valve, whose spring force is equivalent to the pressure force that acts on the pressure face of the valve piston. The valve piston is guided in a low-play valve guide. The fuel leakage flow through the low-play guide is accumulated in a low-pressure chamber defined by the valve piston and is returned to the fuel container via a return.

### DRAWING

The invention is described in further detail below in conjunction with a drawing. Shown are:

Shown are:

FIG. 1, a fuel injection system of the prior art with an electric low-pressure prefeed pump;

FIG. 2, a fuel injection system embodied according to the invention, with an overflow valve;

FIG. 3, an overflow valve embodied according to the invention.

### VARIANT EMBODIMENTS

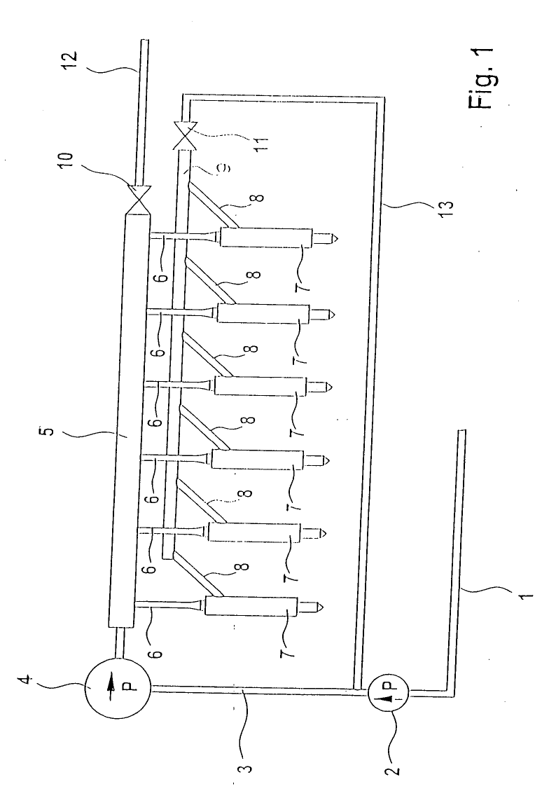

FIG. 1 shows a fuel injection system according to the prior art, with an electric low-pressure prefeed pump.

In a fuel injection system for supplying a self-igniting internal combustion engine, fuel from a fuel container, not shown, is delivered via a fuel supply line 1 to a prefeed pump 2. In the prefeed pump 2, the fuel is precompressed, and it is delivered onward via a low-pressure line 3 to a high-pressure pump 4, in which the fuel is compressed to the pressure of a high-pressure reservoir 5 and then delivered to that reservoir. The pressure in the high-pressure reservoir 5 that is required for engine operation is in the range of from 100 to 2000 bar. From the high-pressure reservoir 5, the fuel is delivered via high-pressure supply lines 6 to injectors 7. Instead of the fuel injection system shown in FIG. 1 with six injectors, with which a six-cylinder engine is associated, the fuel injection system may also include any other number of injectors.

The fuel required for operating the injectors 7 that is not injected into the combustion chamber of the engine is returned to a low-pressure reservoir 9 via injector return lines 8. The pressure in the low-pressure reservoir 9 is maintained such that reliable operation of the injectors is assured. Particularly when piezoelectrically controlled injectors are employed, reliable operation over the entire rpm range of the engine requires a counterpressure at the hydraulic coupler of the injector of between 5 bar and 10 bar.

A constant pressure in the low-pressure reservoir 9 is attained by providing that the low-pressure reservoir 9 is closed off by a pressure holding valve 11. When the opening pressure of the pressure holding valve 11 is exceeded, the pressure holding valve 11 opens, and fuel flows via a low-pressure return to 13 back into the low-pressure line 3. As soon as enough fuel has flowed out of the low-pressure reservoir 9 that the pressure is again-below the opening pressure of the pressure holding valve 11, the pressure holding valve 11 closes again.

When fuel is being continuously pumped by the high-pressure pump 4, in order to keep the pressure in the high-pressure reservoir 5 constant, the high-pressure reservoir 5 is closed off by a pressure regulating valve 10. As soon as the pressure in the high-pressure reservoir 5 exceeds the opening pressure of the pressure regulating valve 10, the pressure regulating valve 10 opens, and fuel travels back into the fuel container via a return line 12. Alternatively, systems with controllable fuel pumping by the high-pressure pump 4 are known, in which the pressure regulation in the high-pressure reservoir 5 is effected by varying the pump delivery, in which case a pressure regulating valve 10 can be dispensed with.

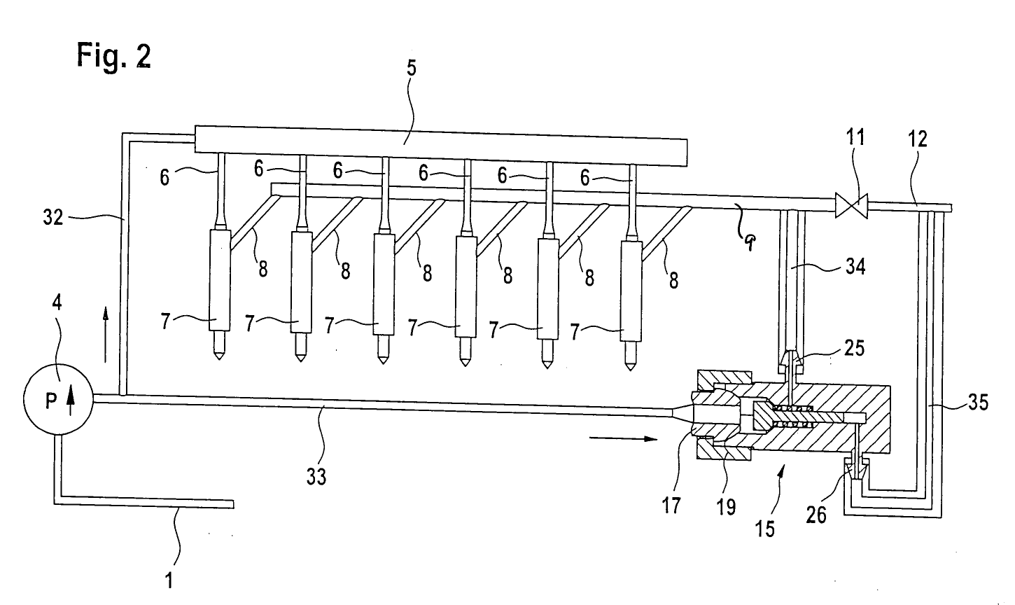

FIG. 2 shows a fuel injection system embodied according to the invention, with an overflow valve.

Unlike FIG. 1, in the fuel injection system embodied according to the invention, there is no prefeed pump 2 between the fuel container and the high-pressure pump 4. In the fuel injection system embodied according to the invention, the fuel is pumped directly from the fuel container into the high-pressure reservoir 5 via the fuel supply line 1 and a high-pressure line 32 by means of the high-pressure pump 4. Typically, a mechanically driven prefeed pump 2 is integrated with the high-pressure pump 4 in such systems, as a result of which the region downstream of the prefeed pump 2 is no longer accessible from outside. Via the high-pressure supply line 6, the injectors 7 are supplied with fuel from the high-pressure reservoir 5. The fuel required for hydraulic operation of the injectors 7 that is not injected into the combustion chambers of the engine is returned to the low-pressure reservoir 9 via the injector return lines 8. The low-pressure reservoir 9 is closed with the pressure holding valve 11. As soon as the pressure in the low-pressure reservoir 9 exceeds the opening pressure of the pressure holding valve 11, the pressure holding valve 11 opens, and fuel flows back into the fuel container via the return line 12.

For filling the low-pressure reservoir before the engine is started, an overflow line 33 branches off from the high-pressure line 32 downstream of the high-pressure pump 4. The overflow line 33 communicates with the low-pressure reservoir 9 via an overflow valve 15 and a low-pressure connection 34. The attachment of the overflow valve 15 to the overflow line 33 may be done for instance by means of a high-pressure connector 17 with a fitting union nut 19. The communication of the overflow valve 15 with the low-pressure connection 34 is effected via a low-pressure connector 25. Fuel that occurs because of an incident leak fuel flow is collected in a low-pressure chamber 28 and is returned to the fuel container via a leak fuel line 35, which communicates with the return line 12. The leak fuel line 35 is secured to the overflow valve 15 by a return connector 26. Since the line on the low-pressure side of the fuel injection system are typically embodied as plastic hoses with integrated woven fabric, the return connector 26 and the low-pressure connector 25 are embodied as connection nipples for hoses.

The overflow valve 15 is constructed such that it is open as long as the pressure in the high-pressure region is less than the closing pressure of the overflow valve 15. The closing pressure of the overflow valve 15 is selected such that it is somewhat lower than the pressure, limited by the pressure holding valve 11, in the low-pressure reservoir 9. As soon as the high-pressure pump 4 begins to pump fuel, in order to build up the requisite pressure in the high-pressure reservoir 5 for engine operation, the low-pressure reservoir 9 is initially also filled, via the open overflow valve 15. As soon as the closing pressure of the overflow valve 15 is reached, the overflow valve 15 is closed by the pressure that has built up in the overflow line 33 by means of the high-pressure pump 4. As soon as the overflow valve 15 is closed, the pressure in the high-pressure reservoir 5 is built up further, until the requisite operating pressure is reached. Filling the low-pressure reservoir 9 via the overflow valve 15 assures that even upon initial triggering of one of the injectors 7, a sufficiently high return counterpressure will prevail at the injectors 7, so that a hydraulic coupler, which is associated with a piezoelectric actuator for stepping up the stroke or in other words lengthening the stroke course, can be reliably filled. The further pressure buildup in the low-pressure reservoir 9 until the operating pressure is reached is then effected by the diversion of the fuel returning from the injectors 7.

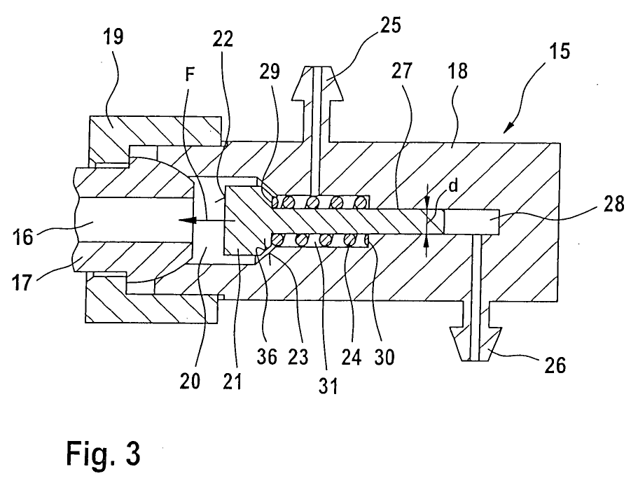

FIG. 3 shows a detailed view of the overflow valve.

The overflow valve 15 includes a valve housing 18, a valve piston 21, and a valve spring 24. A pressure face 22 and a seat face 36 diametrically opposite the pressure face 22 are embodied on the valve piston 21. The seat face 36 together with the valve housing 18 forms a valve seat 23. In the position of the valve piston 21 shown in FIG. 3, the overflow valve 15 is open. The pressure face 22 of the valve piston 21 points in the direction of a high-pressure connection 16. The high-pressure connection 16 includes the high-pressure connector 17, which preferably closes off the overflow line 33. The high-pressure connector 17 is secured to the valve housing 18 by means of the union nut 19. The valve piston 21 is acted upon by the valve spring 24 with a spring force F. The spring force F is dimensioned such that the overflow valve 15 closes when a defined pressure in the high-pressure connection 16 is reached. The force acting on the pressure face 22 of the valve piston 21 can be calculated in accordance with the equation

$$p > {p}_{threshold} = \frac{F \cdot 4}{Π {d}^{2}} .$$

where p=the pressure in the return and d=the diameter of the pressure face 22.

As soon as the pressure on the pressure face 22 exceeds the spring force F of the valve spring 24, the overflow valve 15 closes; this is the case when

$$p \cdot \frac{Π}{4} \cdot d2 ,$$

The valve spring 24 employed for opening the valve rests on a spring bearing face 29 on the valve piston 21 and on a spring chamber boundary wall 30 on the valve housing 18. For receiving the valve spring 24, a spring chamber 31 is received in the valve housing 18. A bore is also made in the valve housing 18, preferably centered relative to the spring chamber 31. The bore acts as a valve guide 27 and forms a low-pressure chamber 28 downstream of the valve piston 21. The diameter of the valve guide 27 d is selected such that the valve piston 21 is guided with little play. For filling of the low-pressure reservoir 9, fuel flows via the high-pressure connection 16 around the valve piston, with the seat face 36 that here is embodied conically, into the spring chamber 31. From there, via the low-pressure connector 25, the fuel leaves the overflow valve 15 in the direction of the low-pressure reservoir 9. Some of the fuel flows along the valve guide 27 into the low-pressure chamber 28. The fuel that flows along the valve guide 27 simultaneously serves to lubricate the valve piston 21 in the valve housing 18. Since the low-pressure chamber 28 is in direct communication with the fuel container, approximately the same pressure prevails in the low-pressure chamber as in the fuel container. Because of the difference in pressure between the spring chamber 31 and the low-pressure chamber 28, replenishing fuel always flows into the low-pressure chamber 28. The fuel from the low-pressure chamber 28 is carried back into the fuel container via the return connector 26.

Instead of the connection nipples, shown in FIG. 3, for the low-pressure connector 25 and the return connector 26, the return connector and the low-pressure connector 25 could assume any other suitable form known to one skilled in the art for connecting the low-pressure connection 34 and the leak fuel line 35. Moreover, the overflow valve 15 may communicate with the overflow line 33 by means of any other releasable or nonreleasable connection known to one skilled in the art, instead of by the screw connection shown that includes the high-pressure connector 17 and the union nut 19. In any case, the connections must be stable with regard to the pressure generated by the high-pressure pump 4. Thus besides the screw connection shown, flange connections or welded connections are also possible, for instance. Moreover, the low-pressure connector 25 or the return connector 26 may also be made in the form of a flange connection, screw connection, or by welding if metal pipelines are used. Particularly for the connectors that are not subjected to high pressure, an adhesive connection is also conceivable.

Besides the conically embodied seat face 36 shown in FIG. 3, the valve seat may instead be embodied as a ball seat, flat seat, or slide, or any other form known to one skilled in the art. For instance, any two-way valve, which closes the communication from the overflow line 13 into the low-pressure reservoir 9 at a predetermined closing pressure is suitable as the overflow valve 15.

### LIST OF REFERENCE NUMERALS

1 Fuel supply line
2 Prefeed pump
3 High-pressure line
4 High-pressure pump
5 High-pressure reservoir
6 High-pressure supply line
7 Injector
8 Injector return line
9 Low-pressure reservoir (return rail)
10 Pressure regulating valve
11 Pressure holding valve
12 Return line
13 Low-pressure return
14 Overflow valve
15 High-pressure connection
16 High-pressure connector
17 Valve housing
18 Union nut
19 Pressure chamber
20 Valve piston
21 Pressure face
22 Valve seat
23 Valve spring
24 Low-pressure connector
25 Return connector
26 Valve guide (low-play)
27 Low-pressure chamber
28 Spring bearing faces
29 Spring chamber boundary wall
30 Spring chamber
31 High-pressure line
32 Overflow line
33 Low-pressure connection
34 Leak fuel line
35 Seat face
F Spring force in opening direction of 21

1-7. (canceled)

8. In a fuel injection system for internal combustion engines, including a high-pressure part and a low-pressure part, in which in the high-pressure part, fuel from a fuel container is delivered to a high-pressure reservoir via a high-pressure pump and a high-pressure line, and injectors are supplied from the high-pressure reservoir via high-pressure supply lines, and in the low-pressure part the injectors communicate via injector return lines with a low-pressure reservoir, and in the low-pressure reservoir by means of a pressure holding valve, a pressure of ≦50 bar is maintained, and at a pressure in the low-pressure reservoir above the opening pressure of the pressure holding valve, the fuel is returned to the fuel container via a return line, the improvement comprising an overflow line connected between and communicating with the low pressure reservoir and the high-pressure line of the high-pressure part via an overflow valve connected in the overflow line.

9. The fuel injection system of claim 8, wherein, when the high-pressure part is pressure-relieved, the overflow valve is opened.

10. The fuel injection system of claim 8 wherein, when a closing pressure that is below the opening pressure of the pressure holding valve is reached, the overflow valve is closed by action of the fuel that is compressed by means of the high-pressure pump.

11. The fuel injection system of claim 8, wherein the overflow valve contains a valve spring, whose spring force F is equivalent to the force exerted on the overflow valve by the closing pressure.

12. The fuel injection system of claim 9, wherein the overflow valve contains a valve spring, whose spring force F is equivalent to the force exerted on the overflow valve by the closing pressure.

13. The fuel injection system of claim 10, wherein the overflow valve contains a valve spring, whose spring force F is equivalent to the force exerted on the overflow valve by the closing pressure.

14. The fuel injection system of claim 8, wherein the overflow valve includes a low-pressure chamber, which communicates with the return line via a leak fuel line.

15. The fuel injection system of claim 9, wherein the overflow valve includes a low-pressure chamber, which communicates with the return line via a leak fuel line.

16. The fuel injection system of claim 10, wherein the overflow valve includes a low-pressure chamber, which communicates with the return line via a leak fuel line.

17. The fuel injection system of claim 11, wherein the overflow valve includes a low-pressure chamber, which communicates with the return line via a leak fuel line.

18. The fuel injection system of claim 8, wherein the injectors are piezoelectrically controlled.

19. The fuel injection system of claim 9, wherein the injectors are piezoelectrically controlled.

20. The fuel injection system of claim 10, wherein the injectors are piezoelectrically controlled.

21. The fuel injection system of claim 11, wherein the injectors are piezoelectrically controlled.

22. The fuel injection system of claim 14, wherein the injectors are piezoelectrically controlled.

23. The fuel injection system of claim 8, wherein the pressure in the low-pressure reservoir is ≦10 bar.

24. The fuel injection system of claim 9, wherein the pressure in the low-pressure reservoir is ≦10 bar.

25. The fuel injection system of claim 10, wherein the pressure in the low-pressure reservoir is ≦10 bar.

26. The fuel injection system of claim 11, wherein the pressure in the low-pressure reservoir is ≦10 bar.

27. The fuel injection system of claim 14, wherein the pressure in the low-pressure reservoir is ≦10 bar.
